(19) United States
(12) Patent Application Publication
(10) Pub. No.: US 2025/0044005 A1
(43) Pub. Date: Feb. 6, 2025

(54) ALARM

(71) Applicant: Mitsubishi Electric Corporation, Tokyo (JP)

(72) Inventors: Yuta SHIOKAWA, Tokyo (JP); Takayuki SETO, Tokyo (JP); Katsuya ISHIGAMI, Tokyo (JP)

(21) Appl. No.: 18/718,214

(22) PCT Filed: Jan. 26, 2023
(86) PCT No.: PCT/JP2023/002342

§ 371 Date: Jun. 10, 2024

(30) Foreign Application Priority Data
Apr. 5, 2022 (WO) PCT/JP2022/017079

(51) Int. Cl. F25B 49/00

(52) U.S. Cl. CPC F25B 49/005; F25B 2500/222

(57) ABSTRACT

An alarm according to an embodiment of the present disclosure comprising a refrigerant sensor capable of detecting a refrigerant, an alarm element that is capable of notifying whether the refrigerant is detected by the refrigerant sensor, an alarm element substrate to which the alarm element is attached to, a sensor substrate to which the refrigerant sensor is attached to, and a housing that houses the alarm element and the sensor substrate on an inside thereof. The sensor substrate is a separate body from the alarm element substrate, and is electrically connected to the alarm element substrate. The housing has a housing main body that holds the alarm element substrate and the sensor substrate, and a lid that is detachably fixed to the housing main body, and that covers the alarm element substrate and the sensor substrate. The sensor substrate is detachably fixed to the housing main body.

### CROSS-REFERENCE TO RELATED APPLICATIONS

This application is a U.S. national stage application of PCT/JP2023/002342 filed on Jan. 26, 2023, which claims priority to International Patent Application No. PCT/JP2022/017079 filed on Apr. 5, 2022, the contents of which are incorporated herein by reference.

### TECHNICAL FIELD

The present disclosure relates to an alarm.

### BACKGROUND

For example, as shown in Patent Document 1, a refrigerant leak detector (alarm) that detects and informs when a refrigerant is leaking is known.

### PATENT DOCUMENT

[Patent Document 1] Japanese Unexamined Application. No. 2012-193884, First Publication

In the refrigerant leak detector mentioned above, it is often the case for example, where a semiconductor type refrigerant sensor is used as a refrigerant sensor. The semiconductor type refrigerant sensor is not able to detect a refrigerant leak, after the refrigerant sensor detects a refrigerant leak once. Therefore, there is a need to exchange the refrigerant sensor. However, in a conventional refrigerant leak detector, to change the refrigerant sensor, for example, a substrate having an alarm element and the refrigerant sensor attached thereto needs to be exchanged as a whole, or the entirety of the refrigerant leak detector itself needs to be changed or the like. As such, a big problem of relatively large amounts of time and effort, as well as cost being required when exchanging the refrigerant sensor exists.

### SUMMARY

The present disclosure has been made in order to address the aforementioned problem, and one object is to provide an alarm having a construction that makes exchange of a refrigerant sensor easy.

An alarm according to an embodiment of the present disclosure comprising a refrigerant sensor capable of detecting a refrigerant, an alarm element that is capable of notifying whether the refrigerant is detected by the refrigerant sensor, an alarm element substrate to which the alarm element is attached to, a sensor substrate to which the refrigerant sensor is attached to, and a housing that houses the alarm element and the sensor substrate on an inside thereof. The sensor substrate is a separate body from the alarm element substrate, and is electrically connected to the alarm element substrate. The housing has a housing main body that holds the alarm element substrate and the sensor substrate, and a lid that is detachably fixed to the housing main body, and that covers the alarm element substrate and the sensor substrate. The sensor substrate is detachably fixed to the housing main body.

According to the present disclosure, it is possible to provide an alarm where exchange of a refrigerant sensor is easy.

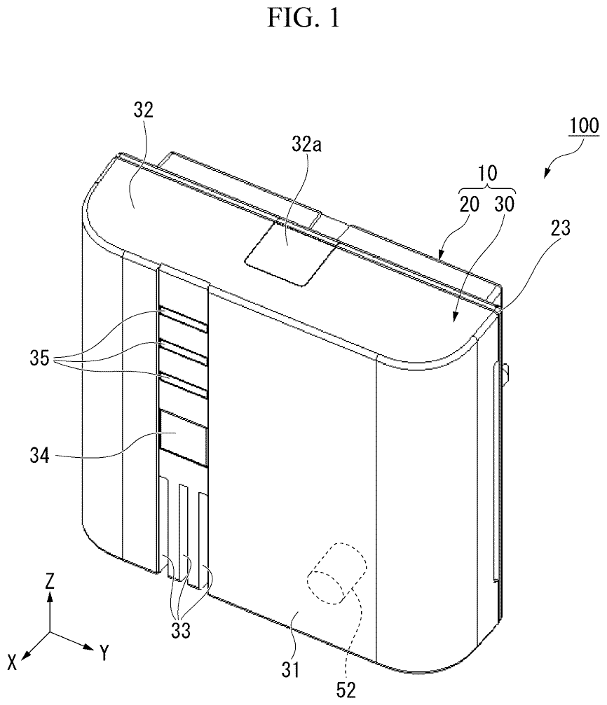

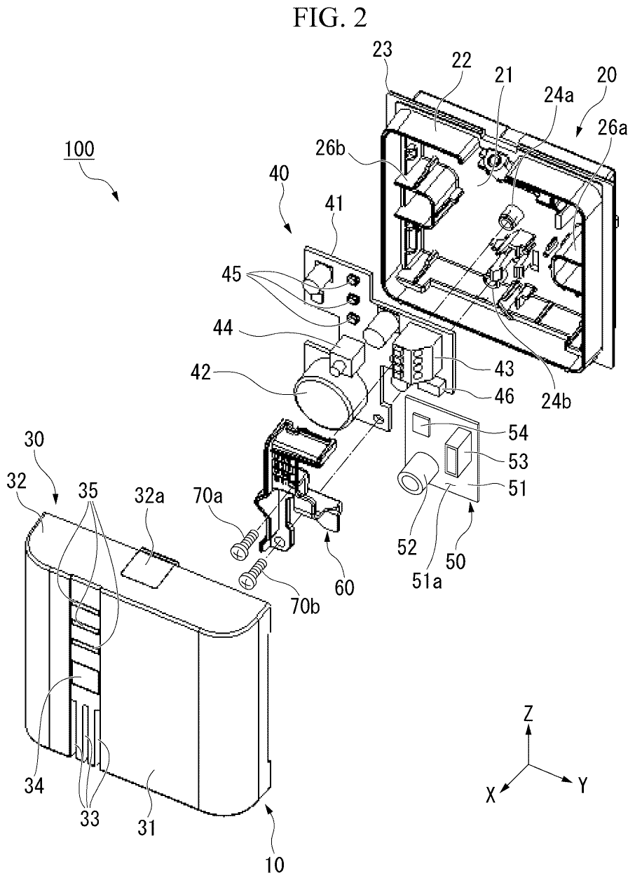

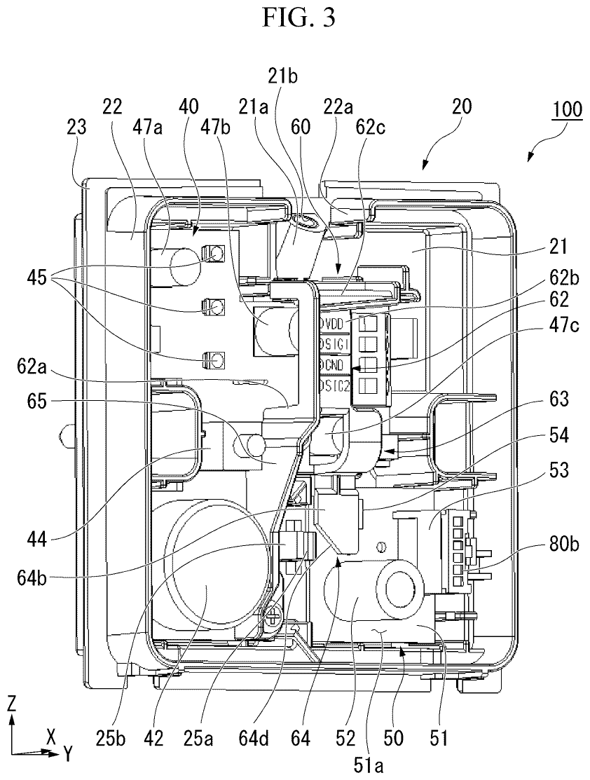

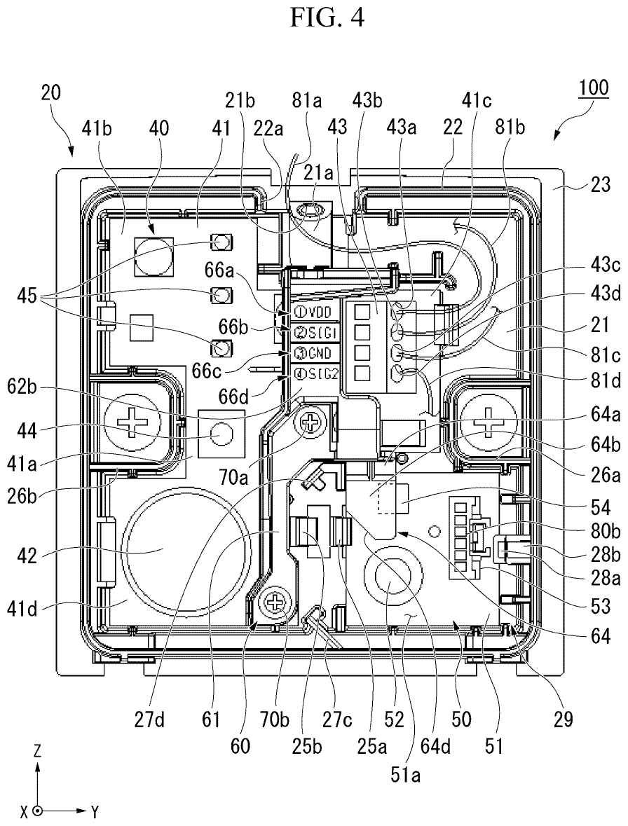

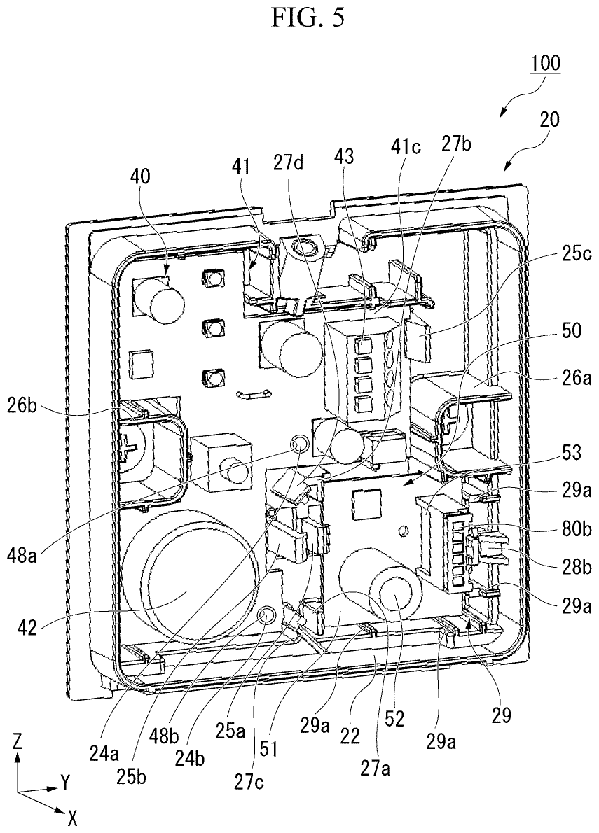

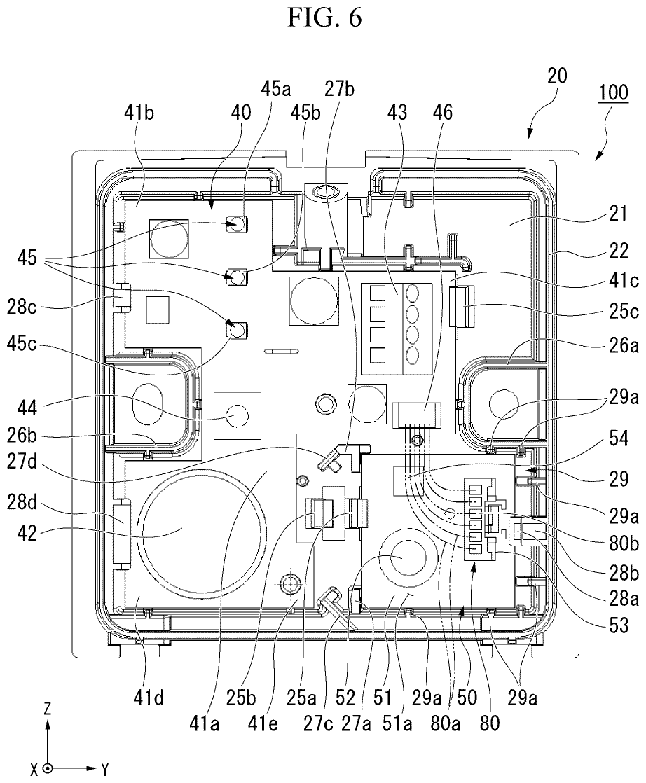

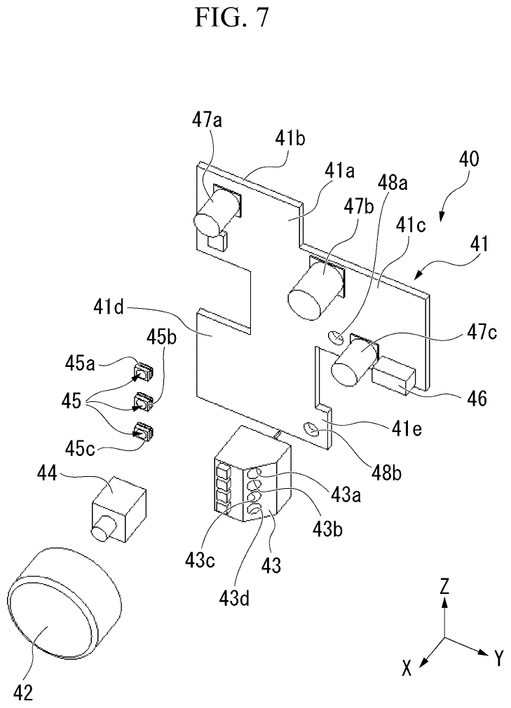

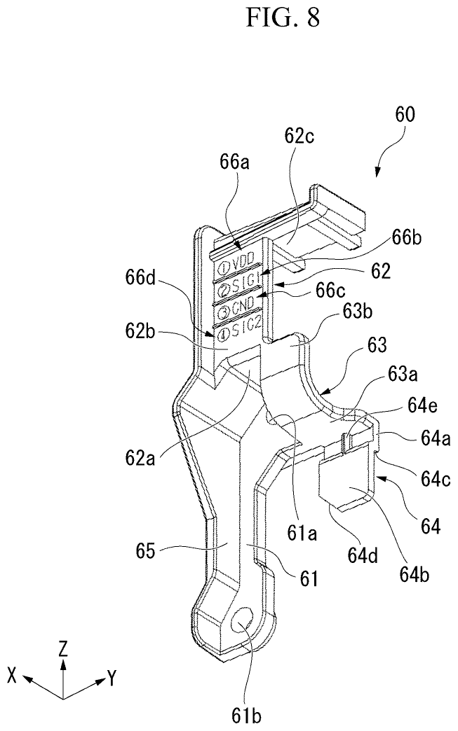

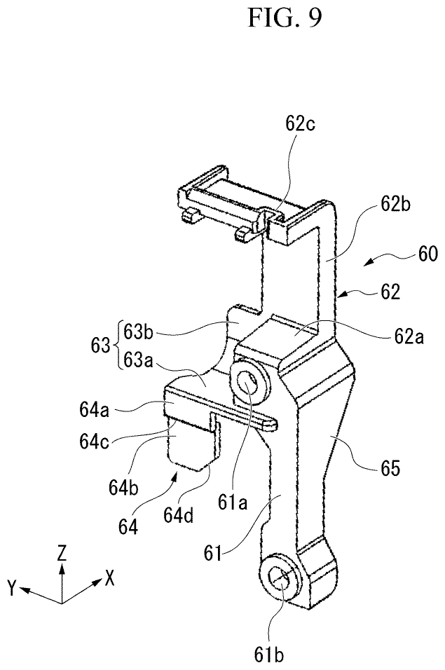

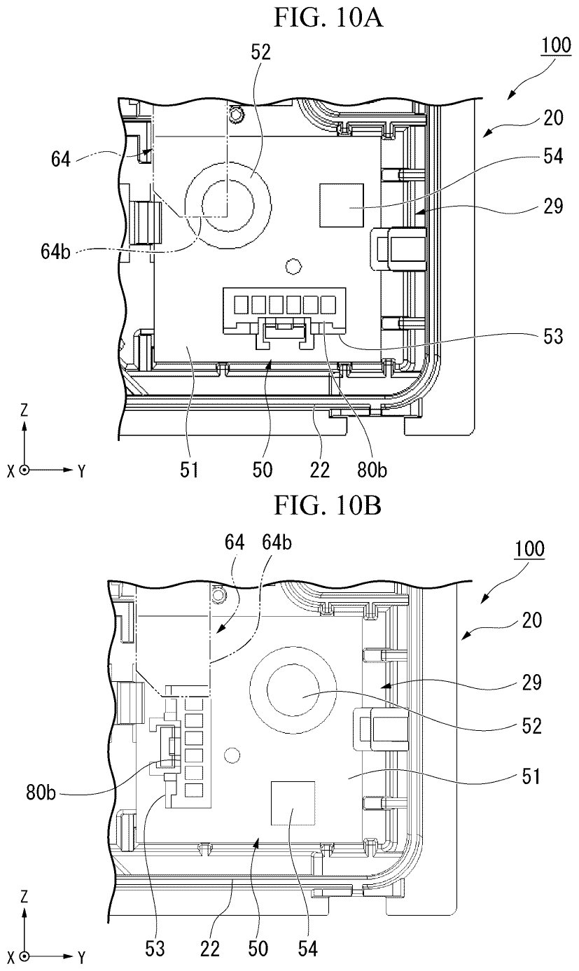

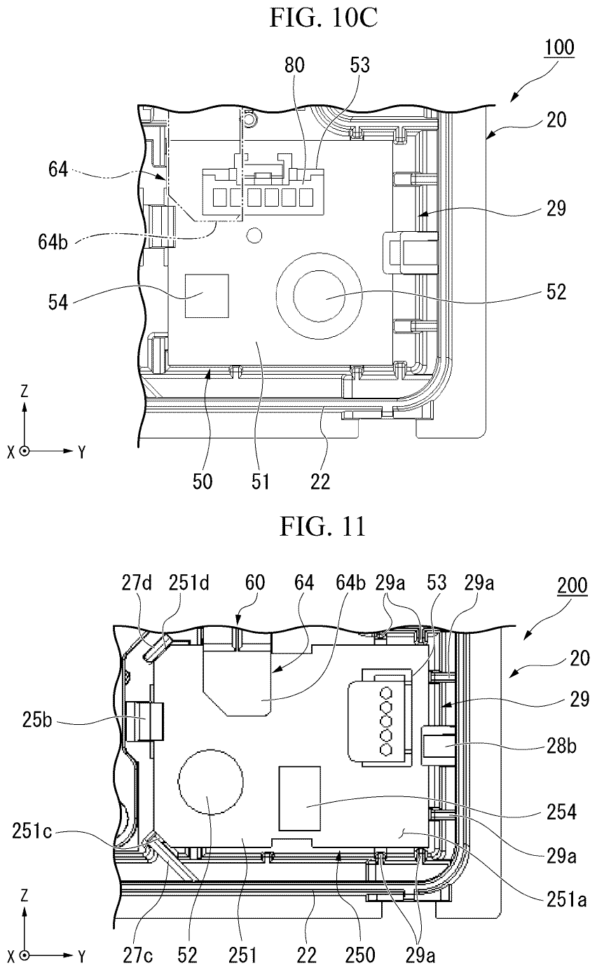

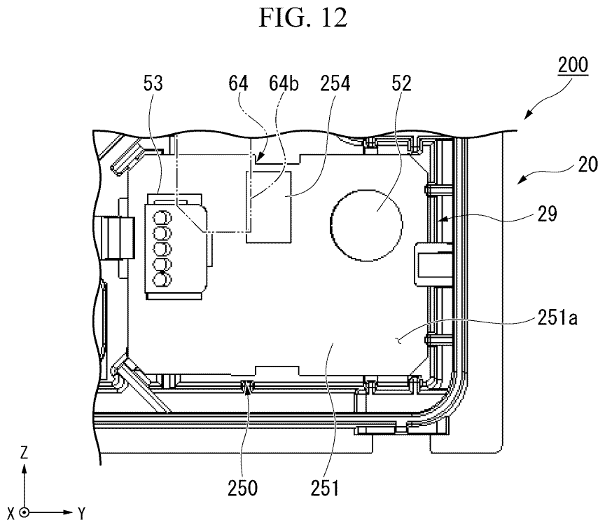

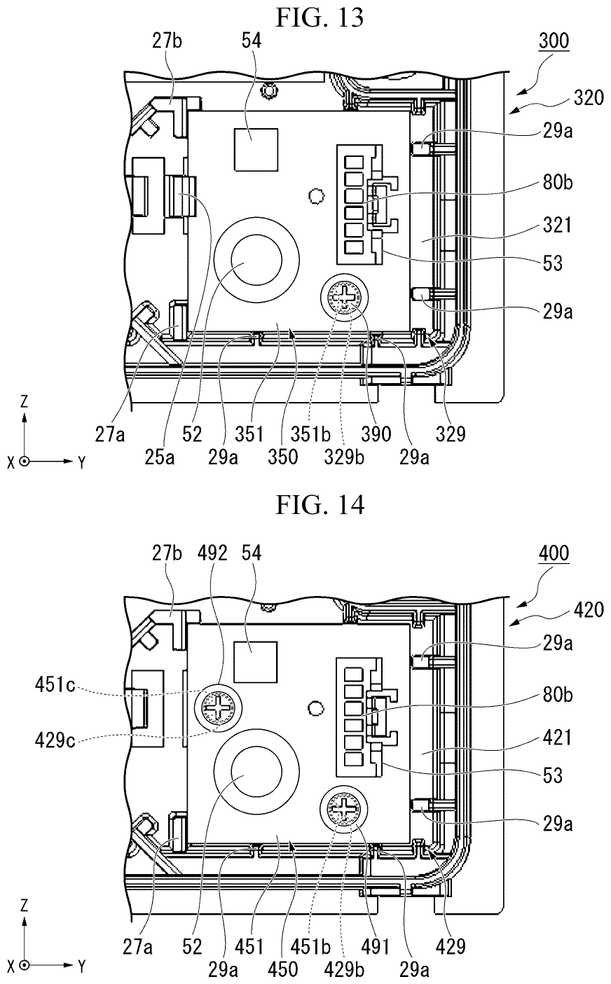

### BRIEF DESCRIPTION OF DRAWINGS

[FIG. 1] A perspective view that shows an alarm in a first embodiment.

[FIG. 2] An exploded perspective view that shows the alarm in the first embodiment.

[FIG. 3] A perspective view that shows a part of the alarm in the first embodiment, and shows a state where a lid is removed.

[FIG. 4] A view that shows a part of the alarm as seen from a front side in the first embodiment, and shows a state where the lid is removed.

[FIG. 5] A perspective view that shows a part of the alarm in the first embodiment, and shows a state where the lid and a covering member are removed.

[FIG. 6] A view that shows a part of the alarm as seen from the front side in the first embodiment, and shows a state where the lid and the covering member are removed.

[FIG. 7] An exploded perspective view that shows a first substrate unit in the first embodiment.

[FIG. 8] A perspective view that shows the covering member in the first embodiment.

[FIG. 9] A perspective view that shows the covering member in the first embodiment, and shows the covering member from a different angle than that of FIG. 8.

[FIG. 10A] A view that shows a sensor substrate in a state of being attached to a housing main body in a different orientation, in the first embodiment.

[FIG. 10B] A view that shows the sensor substrate in a state of being attached to the housing main body in another different orientation, in the first embodiment.

[FIG. 10C] A view that shows the sensor substrate in a state of being attached to the housing main body in yet another different orientation, in the first embodiment.

[FIG. 11] A view that shows a part of the alarm from the front side, in a second embodiment.

[FIG. 12] A view that shows the sensor substrate in a state of being attached to the housing main body in a different orientation, in the second embodiment.

[FIG. 13] A view that shows a part of the alarm from the front side, in a third embodiment.

[FIG. 14] A view that shows a part of the alarm from the front side, in a fourth embodiment.

### DETAILED DESCRIPTION

Hereinafter, embodiments of the present disclosure are explained with reference to the drawings. The scope of the present disclosure is not limited to the embodiments below, and may be changed so long as the embodiments do not depart from the technical scope of the present disclosure. In the drawings below, to facilitate better understanding of the various embodiments, scales and dimensions or the like of various constructions may differ from scales and dimensions or the like of constructions in the drawings below.

The drawings show an X axis, a Y axis, and a Z axis where appropriate. In the explanation below, a direction along the X axis is referred to as a “front-rear direction X”, a direction along the Y axis is referred to as a “left-right direction Y”, and a direction along the Z axis is referred to as a “top-bottom direction Z”. The front-rear direction X, the left-right direction Y. and the up-down direction Z are mutually orthogonal directions. In the explanation below, a side out of sides of the up-down direction Z in which an arrow of the Z axis faces is a top side (+Z side). The other side out of sides of the up-down direction Z which faces an opposite side the arrow of the Z axis faces, is a bottom side (−Z side). A side out of sides of the front-rear direction X in which an arrow of the X axis faces is a front side (+X side). A side out of sides of the front-rear direction X which faces an opposite side the arrow of the X axis faces is a rear side (−X side). The left-right direction Y in the embodiment below, is the left-right direction Y in a case where an alarm is viewed from the front side (+X side). In other words, a side out of sides of the left-right direction Y in which an arrow of the Y axis faces is a right side (+Y side). A side out of sides in the left-right direction Y which faces an opposite side the arrow of the Y axis faces is a left side (−Y side). In the embodiments below, the front-rear direction X corresponds to a “first direction”, the left-right direction Y corresponds to a “second direction” which is orthogonal to the first direction, and the front side refers to “one side of the first direction”.

### First Embodiment

FIG. 1 is a perspective view that shows an alarm 100 in a first embodiment. FIG. 2 is an exploded perspective view that shows the alarm 100 in the first embodiment. FIG. 3 is a perspective view that shows a part of the alarm 100 in the first embodiment, and shows a state where a lid 30, to be mentioned later on, is removed. FIG. 4 is a view that shows a part of the alarm 100 as seen from a front side in the first embodiment, and shows a state where the lid 30, to be mentioned later on, is removed. FIG. 5 is a perspective view that shows a part of the alarm 100 in the first embodiment, and shows a state where the lid 30 and a covering member 60, to be mentioned later on, are removed. FIG. 6 is a view that shows a part of the alarm 100 as seen from the front side in the first embodiment, and shows a state where the lid 30 and the covering member 60, to be mentioned later on, are removed.

The alarm 100 in the first embodiment, shown in FIG. 1, is an alarm that detects a refrigerant, and alerts a user that a refrigerant is detected. The refrigerant for example, is a refrigerant that is used in a refrigeration cycle device of an air conditioner or the like. A refrigerant such as a fluorine based refrigerant with a low global warming potential (GWP: Global Warming Potential), or a hydrocarbon based refrigerant or the like may be mentioned as examples of the refrigerant. Any one of refrigerants R1234yf, R1234ze, R32, and R290 used as a single refrigerant, a mix of two or more of said refrigerants, or in combination with other refrigerants may also be mentioned as examples of the refrigerant. A mixed refrigerant that includes R1132 (E), or a mixed refrigerant that includes R1123 may be mentioned as examples of the refrigerant. Mixed refrigerants R516A, R445A, R444A, R454C, R444B, R454A, R455A, R457A, R459B, R452B, R454B, R447B, R447A, R446A, and R459A may also be mentioned as examples of the refrigerant. A density of the refrigerant in a gaseous state is larger than a density of air. The alarm 100 is for example, fixed in a vicinity of a wall or the like to which an indoor unit of an air conditioner is disposed, or in the vicinity of a location that is lower than the location of the indoor unit.

As shown in FIG. 1, the alarm 100 in the first embodiment is semi-rectangular in shape. The alarm 100, as seen from the front-rear direction X, is a semi-rectangular shape that has a pair of sides that extend in the left-right direction Y, and a pair of sides that extend in the up-down direction Z. The alarm 100 includes a semi-rectangular box shaped housing 10. The housing 10 for example, is made of resin. The housing 10 includes a housing main body 20, and a lid 30. The housing main body 20 and the lid 30 are entities that are separate from one another. The lid 30 is located on the front side (+X side) of the housing main body 20. The lid 30 is detachably fixed to the housing main body 20.

As shown in FIG. 2, the housing main body 20 is a box shape that opens to the front side (+X side). The housing main body 20 has a rear wall 21, an inner circumferential wall 22, and a flange 23. The rear wall 21 is a semi-rectangular plate. A plate surface of the rear wall 21 faces the front-rear direction X. The inner circumferential wall 22 protrudes to the front side, from an outside of the rear wall 21. The inner circumferential wall 22 is a semi-rectangular frame shape, as seen in the front-rear direction X. As shown in FIG. 3 and FIG. 4, a through hole 22a that penetrates a wall portion located on the top side out of the inner circumferential wall 22 in the top-bottom direction Z, is formed on a center part in the left-right direction Y on said wall portion. The flange 23 protrudes so as to face an outside of the inner circumferential wall 22, from an outer circumferential surface of the inner circumferential wall 22. The flange 23 is a semi-rectangular frame shape that surrounds the inner circumferential wall 22.

A lid fixing portion 21a is formed on a center part in the left-right direction Y on an edge of the top side out of the rear wall 21. The lid fixing portion 21a protrudes to the front side and the top side from a front side (+X side) surface of the rear wall 21. The lid fixing portion 21a is disposed so as to face a bottom side of the through hole 22a. A thread hole 21b to which a bolt that fixes the lid 30 is formed on the lid fixing portion 21a. The thread hole 21b opens to the front side and to the top side, on a tip surface of the lid fixing portion 21a. The tip surface of the lid fixing portion 21a is an end surface on an end on the front side and on the top side of the lid fixing portion 21a, and faces the front side and the top side. By fastening a bolt that passes through a hole not shown on the drawings, that is formed on the lid 30, to the thread hole 21b, the housing main body 20 and the lid 30 are fixed to one another. As such, by having the lid fixing portion 21a protrude in a direction that inclines to the front-rear direction X with respect to the top-bottom direction Z, and having the thread hole 21b formed on the lid fixing portion 21a open to a direction that inclines in the front-rear direction X with respect to a direction directly above, it is easier for an operator to visually confirm when fastening the bolt to the thread hole 21b without needing to check from directly above the thread hole 21b. Specifically, in the first embodiment, it is possible for the operator to easily confirm the thread hole 21b from the front side. As such, it is possible to improve workability of fixing the housing main body 20 to the lid 30 using a bolt.

As shown in FIG. 2, each of a pair of protruding walls 26a and 26b are formed on a center part in the top-bottom direction Z on both ends in the left-right direction Y out of the front side (+X side) surface of the rear wall 21. The pair of protruding walls 26a and 26b protrude to the front side (+X side) from the rear wall 21. The pair of protruding walls 26a and 26b are connected to an inside surface of the inner circumferential wall 22. The protruding wall 26a is a semi-U shape that opens to the right side, as seen in the front-rear direction X. An end of the protruding wall 26a on the right side is connected to a wall portion located on the right side, out of the inner circumferential wall 22. The protruding wall 26b is a semi-U shape that opens to the left side, as seen in the front-rear direction X. An end of the protruding wall 26b in the left side is connected to a wall portion located on the left side, out of the inner circumferential wall 22. Bolt holes to insert bolts used to fix the rear wall 21 to an indoor wall or the like are formed on a portion out of the rear wall 21 that is surrounded by the protruding wall 26a as seen in the left-right direction X, and a portion out of the rear wall 21 that is surrounded by the protruding wall 26b as seen in the left-right direction X.

Substrate fixing portions 24a and 24b are formed on the front side (+X side) surface of the rear wall 21. The substrate fixing portions 24a and 24b are cylindrical shapes that protrude to the front side from the rear wall 21. The substrate fixing portions 24a and 24b are located to the bottom side more than the lid fixing portion 21a. Female thread holes that are formed on tips of the substrate fixing portions 24a and 24b, have bolts 70a and 70b to be mentioned later on, which are used to fix the covering member 60, fastened to said female thread holes. The substrate fixing portion 24a is provided on a center part in the left-right direction Y and in the top-bottom direction Z, out of the front side surface of the rear wall 21. The substrate fixing portion 24b is provided on a bottom end in a center part in the left-right direction Y, out of the front side surface of the rear wall 21. The substrate fixing portion 24b is located to the left side and to the bottom side, more than the substrate fixing portion 24a.

As shown in FIG. 5 and in FIG. 6, the housing main body 20 has a substrate holding portion 29 that holds a sensor substrate 51 to be mentioned later on. The substrate holding portion 29 is formed on a bottom side portion on a right side portion out of an inside of the inner circumferential wall 22. The substrate holding portion 29 has a plurality of ribs 29a. The plurality of ribs 29a include the plurality of ribs 29a that are formed on a wall portion located on the bottom side out of the inner circumferential wall 22, the plurality of ribs 29a that are formed on a wall portion located on the right side out of the inner circumferential wall 22, and the plurality of ribs 29a that are formed on a wall portion located on the bottom side out of the protruding wall 26a.

The substrate holding portion 29 has elastic claws 25a and 25b, fixed claws 28a and 28b, and supports 27a, 27b, 27c, and 27d. The elastic claws 25a and 25b, the fixed claws 28a and 28b, and the supports 27a, 27b, 27c, and 27d protrude to the front side (+X side) from the rear wall 21. The elastic claws 25a and 25b and the supports 27a, 27b, 27c, and 27d are located on a left side portion out of the substrate holding portion 29. The fixed claws 28a and 28b are located on a right side portion out of the substrate holding portion 29. In the first embodiment, the elastic claw 25a and the fixed claw 28a are claw portions that detachably fix the sensor substrate 51 to be mentioned later on. The elastic claw 25b and the fixed claw 28b are claw portions that detachably fix a sensor substrate 251 to be mentioned later on in a second embodiment. In the first embodiment, the elastic claw 25a corresponds to a “first claw”, and the fixed claw 28a corresponds to a “second claw”.

The elastic claws 25a and 25b are elastically deformable in the left-right direction Y. As shown in FIG. 5, the elastic claw 25b is disposed to the left side of the elastic claw 25a with an interval therebetween. The elastic claw 25b protrudes to the front side (+X side) more than the elastic claw 25a.

Opposing supports 27a and 27b have the elastic claw 25a disposed therebetween in the top-bottom direction Z. The support 27b is located to the top side more than the support 27a. Opposing supports 27c and 27d have the elastic claw 25b disposed therebetween in the top-bottom direction Z. The support 27d is located to the top side more than the support 27c. The support 27d is connected to the support 27b from the left side. In the first embodiment, the opposing supports 27a and 27b are supports that hold that sensor substrate 51 to be mentioned later on. The opposing supports 27c and 27d are supports that hold the sensor substrate 251 to be mentioned later on in the second embodiment.

As shown in FIG. 6, the fixed claws 28a and 28b are disposed in a location so as to sandwich the sensor substrate 51 in the left-right direction Y, in between with the elastic claws 25a and 25b. In other words, the elastic claws 25a and 25b and the fixed claws 28a and 28b are disposed so as to sandwich the sensor substrate 51 in the left-right direction Y that is orthogonal to the front-rear direction X. The fixed claw 28b is located to the right side of the fixed claw 28a. The fixed claw 28b protrudes to the front side (+X side) more than the fixed claw 28a.

The housing main body 20 has an elastic claw 25c, and fixed claws 28c and 28d. The elastic claw 25c and the fixed claws 28c and 28d are claw portions that hold an alarm element substrate 41 to be mentioned later on. The elastic claw 25c and the fixed claws 28c and 28d protrude to the front side (+X side) from the rear wall 21. The elastic claw 25c is disposed on a right side portion on a top side portion of the rear wall 21. The elastic claw 25c is elastically deformable in the left-right direction Y. The fixed claws 28c and 28d are disposed on an end of the rear wall 21 in the left side. The fixed claw 28d is located to the bottom side more than the fixed claw 28c. As seen in the front-rear direction X, the fixed claw 28c and the fixed claw 28d are disposed so as to sandwich the protruding wall 26b in the top-bottom direction Z.

As shown in FIG. 1 and in FIG. 2, the lid 30 is a semi-rectangular box shaped that opens to the rear side (−X side). The lid 30 covers a first substrate unit 40 and a second substrate unit 50 to be mentioned later on, from the front side (+X side). The lid 30 has a front wall 31, and an outer circumferential wall 32. The front wall 31 is a semi-square shaped plate. A plate surface of the front wall 31 faces the front-rear direction X. The front wall 31 is disposed so as to face the rear wall 21 from the front side thereof, with an interval therebetween.

The outer circumferential wall 32 protrudes to the rear side (−X side) from an outer edge of the front wall 31. The outer circumferential wall 32 is a semi-square frame shape, as seen in the front-rear direction X. The inner circumferential wall 22 is fitted to an inside of the outer circumferential wall 32. An end of the outer circumferential wall 32 in the rear side contacts a surface on the front side (+X side) of the flange 23. A covered portion 32a, which covers a bolt head of the bolt fastened to the lid fixing portion 21a and the thread hole 21b of the lid fixing portion 21a formed on the housing main body 20, is formed on a center part in the left-right direction Y of a wall portion on the top side out of the outer circumferential wall 32. As such, it is possible to suppress said bolt head from being exposed to an outside of the alarm 100 using the covered portion 32a, and it is possible to improve a design quality of the alarm 100. It is possible to open and to close the covered portion 32a. In a state where the covered portion 32a is open, said bolt head of the bolt used to fix the lid 30 to the housing main body 20 is exposed to an outside of the housing 10.

An air intake hole 33 is formed on the front wall 31, in the lid 30. The air intake hole 33 in the first embodiment is formed on an end of the bottom side on a left side portion of the front wall 31. The air intake hole 33 extends in the top-bottom direction Z. A plurality of air intake holes 33 are provided in the left-right direction Y with intervals therebetween. In the first embodiment, three air intake holes 33 are provided.

A stop switch 34 is provided on a part out of the front wall 31, located on the top side of the air intake hole 33. By the user pressing the stop switch 34, it is possible for a user to stop an alarm of the alarm 100. A plurality of windows 35 are adjacently formed with intervals therebetween in the top-bottom direction Z, in a part out of the front wall 31 located on the top side of the stop switch 34.

As explained above, the lid 30 is detachably fixed to the housing main body 20. An operator removing the lid 30 from the housing main body 20 opens the covered portion 32a of the lid 30 to expose said bolt head of the bolt used to fix the lid 30 to the housing main body 20, and removes the bolt. Accordingly, it is possible for the operator to remove the lid 30 from the housing main body 20.

As shown in FIG. 2, the alarm 100 includes the first substrate unit 40 and the second substrate unit 50. The first substrate unit 40 and the second substrate unit 50 are housed on an inside of the housing 10. As shown in FIG. 5 and in FIG. 6, the first substrate unit 40 is held so as to straddle between a left side portion and a top side portion out of the housing main body 20. The second substrate unit 50 is held by the substrate holding portion 29.

FIG. 7 is an exploded perspective view that shows the first substrate unit 40. As shown in FIG. 7 the first substrate unit 40 has the alarm element substrate 41, a speaker 42, a terminal block 43, a switching element 44, luminous bodies 45, a first connector 46, and electric parts 47a, 47b, and 47c.

The alarm element substrate 41 is a plate shape that has a plate surface which faces the front-rear direction X. The plate surface of the alarm element substrate 41 is orthogonal to the front-rear direction X. The speaker 42, the terminal block 43, the switching element 44, the luminous bodies 45, the first connector 46, and the electric parts 47a, 47b, and 47c are attached to a surface on the front side (+X side) of the alarm element substrate 41. The speaker 42, the terminal block 43, the switching element 44, the luminous bodies 45, the first connector 46, and the electric parts 47a, 47b, and 47c are electrically connected to the alarm element substrate 41. For example, the speaker 42, the terminal block 43, the switching element 44, the luminous bodies 45, the first connector 46, and the electric parts 47a, 47b, and 47c are electrically connected to the alarm element substrate 41 via soldering. The alarm element substrate 41 is a printed circuit board that has a conductive wiring pattern.

The alarm element substrate 41 has a first portion 41a, a second portion 41b, a third portion 41c, a fourth portion 41d, and a fifth portion 41e. The first portion 41a extends in the top-bottom direction Z. The second portion 41b protrudes to the left side from a top end of the first direction 41a. The third portion 41c protrudes to the right side from the first portion 41a. Atop end of the third portion 41c is located more to the bottom side than a top end of the first portion 41a. The fourth portion 41d protrudes to the left side from a bottom side of the first portion 41a. The fourth portion 41d is disposed on a bottom side of the second portion 41b, at an interval therefrom. The fifth portion 41e protrudes to the right side, from a bottom end of the first portion 41a. A right end of the fifth portion 41e is located to the left side, more than a right end of the third portion 41c. The fifth portion 41e is disposed on the bottom side of a left end of the third portion 41c, at an interval therefrom.

Bolt holes 48a and 48b that penetrate the alarm element substrate 41 in the front-rear direction X, are formed on the alarm element substrate 41. The bolt hole 48a is formed on a left end in a bottom end of the third portion 41c. The bolt 70a which is fastened to the female thread hole of the substrate fixing portion 24a, is inserted through the bolt hole 48a. The bolt hole 48b is formed on a connection portion of the first portion 41a and the fifth portion 41e. The bolt 70b which is fastened to the female thread hole of the substrate fixing portion 24b, is inserted through the bolt hole 48b.

As shown in FIG. 6, the alarm element substrate 41 is held by the housing main body 20. The alarm element substrate 41 in the first embodiment is fixed to the housing main body 20 by having the elastic claw 25c and the fixed claws 28c and 28d hook onto edges of the alarm element substrate 41 from the front side (+X side), as well as having the bolts 70a and 70b which are inserted through the bolt holes 48a and 48b, be fastened to the female thread holes of the substrate fixing portions 24a and 24b. The elastic claw 25c hooks onto an edge on the right side of the third portion 41c from the front side. The fixed claw 28c is hooked onto an edge on the left side of the second portion 41b from the front side. The fixed claw 28d hooks onto an edge on the left side of the fourth portion 41d from the front side.

The speaker 42 is a cylindrical shape having an axis that extends in the front-rear direction X as a center thereof. The speaker 42 is disposed so as to straddle the first portion 41a and the fourth portion 41d. The speaker 42 is an alarm element that is capable of notifying whether a refrigerant is detected by a refrigerant sensor 52 to be mentioned later on. When the refrigerant sensor 52 detects the refrigerant, the speaker 42 notifies the user or the like that the refrigerant sensor 52 detects a refrigerant, by producing a sound. The speaker 42 for example, may be a simple buzzer that produces a continuous sound. When the refrigerant sensor 52 detects the refrigerant, for example, a simple continuous sound, as an alarm which informs the user that the refrigerant is leaking from the indoor unit of the air conditioner, is produced from the speaker 42. The speaker 42 may also be a speaker that produces a sound which informs the user or the like that the refrigerant is leaking from the indoor unit of the air conditioner, when the refrigerant is detected by the refrigerant sensor 52.

The terminal block 43 is disposed in the third portion 41c. As shown in FIG. 4, the terminal block 43 has a plurality of connectors 43a, 43b, 43c, and 43d. Each of the plurality of connectors 43a, 43b, 43c, and 43d in the first embodiment is a hole that opens to the right side. The connector 43a, the connector 43b, the connector 43c, and the connector 43d are disposed adjacently in such order, from the top side to the bottom side.

A wire 81a is connected to the connector 43a. A wire 81b is connected to the connector 43b. A wire 81c is connected to the connector 43c. A wire 81d is connected to the connector 43d. Each of the wires 81a, 81b, 81c, and 81d are electrically connected to the alarm element substrate 41 via the terminal block 43. The wire 81a is an electric power line. The wire 81b and the wire 81c are signal lines. The wire 81c is aground wire. Each of the wires 81a, 81b, 81c, and 81d are for example, passed through the through hole 22a formed on the inner circumferential wall 22, and are pulled to the outside of the housing 10. The wire 81a and the wire 81c are connected to an outside electric power supply source, provided on the outside of the alarm 100. The wire 81b and the wire 81d are connected to electronic devices provided on the outside of the alarm 100. Electric power is supplied to the alarm 100 via the wire 81a, which is an electric power line, from the outside electric power supply source.

Wires that are connected to the terminal block 43 may include other wires that are electrically connected to other parts on the inside of the housing 10. For example, said wires connected to the terminal block 43, may include wires that are electrically connected to the sensor substrate 51 to be mentioned later on. For example, the previously mentioned wire 81b or the wire 81d may be electrically connected to the sensor substrate 51.

The switching element 44 is disposed on the center part of the top-bottom direction Z in the first portion 41a. The switching element 44 is located on the rear side (−X side) of the stop switch 34 of the lid 30. By having the user press the stop switch 34, the switching element 44 is pressed, and an alarm of the alarm 100 stops.

As shown in FIG. 6, the luminous bodies 45 are disposed on a top side portion of the first portion 41a. The luminous bodies 45 are for example, luminous diodes (LED: Light Emitting Diode). In the first embodiment, a plurality of the luminous bodies 45 are disposed with intervals therebetween, in the top-bottom direction Z. Three luminous bodies 45 provided in the first embodiment are luminous body 45a, luminous body 45b, and luminous body 45c. The luminous body 45a, the luminous body 45b, and the luminous body 45c are adjacently disposed in such order, with an interval therebetween, as the bottom side is approached from the top side.

Out of the luminous bodies 45, the luminous body 45a shows a state of electric power supply of the alarm 100. The luminous body 45a emits a light when electric power is being supplied to the alarm 100. The luminous body 45b is an alarm element that is capable of notifying whether the refrigerant is detected by the refrigerant sensor 52 to be mentioned later on. The luminous body 45b emits a light when the refrigerant is detected by the refrigerant sensor 52. Out of the luminous bodies 45, the luminous body 45c indicates whether any sort of malfunction occurs at the alarm 100. The luminous body 45c emits a light when any sort of malfunction occurs at the alarm 100. Light that is emitted from each of the luminous bodies 45a, 45b, 45c is emitted to the outside of the housing 10 via each window of window 35 formed on the lid 30. Accordingly, the user or the like is able to visually confirm the light being emitted from each of the luminous bodies 45a, 45b, and 45c from the outside of the alarm 100.

The first connector 46 is disposed on an end on the right side on an end on the bottom side out of the third portion 41c. The first connector 46 is located on the bottom side of the terminal block 43. A cable 80 that connects the alarm element substrate 41 and the sensor substrate 51 to be mentioned later on is connected to the first connector 46. The cable 80 has a plurality of wires 80a that extend from the first connector 46, and cable connectors 80b which have tip ends of the plurality of wires 80a connected thereto. By having the cable connectors 80b be connected to a second connector 53 to be mentioned later on, the alarm element substrate 41 and the sensor substrate 51, to be mentioned later on, are electrically connected via the cable 80.

As shown in FIG. 7, the electric parts 47a, 47b, and 47c extend as cylindrical shapes in the front-rear direction X. The electric parts 47a, 47b, and 47c are capacitors for example. The electric part 47a is disposed on an end of the left side on a top side portion of the second portion 41b. The electric part 47b is disposed on an end on the left side on an end of the top side of the third portion 41c. The electric part 47c is disposed on a center part in the left-right direction Y on an end of the bottom side of the third portion 41c. The electric part 47c is located between the bolt hole 48a and the first connector 46 in the left-right direction Y.

As shown in FIG. 6, the second substrate unit 50 is held by the substrate holding portion 29. The second substrate unit 50 is located on the bottom side of the third portion 41c on the alarm element substrate 41, as well as a bottom side portion of the first portion 41a and the right side of the fifth portion 41e. The second substrate unit 50 has the sensor substrate 51, the refrigerant sensor 52, the second connector 53, and an IC chip 54.

The sensor substrate 51 is a separate body from the alarm element substrate 41. The sensor substrate 51 is separately disposed from the alarm element substrate 41. The sensor substrate 51 is located on the bottom side of the third portion 41c, as well as a bottom side portion of the first portion 41a and the right side of the fifth portion 41e, on the alarm element substrate 41. The sensor substrate 51 is a square shaped plate having a plate surface that faces the front-rear direction X. A plate surface of the sensor substrate 51 is orthogonal with the front-rear direction X. The sensor substrate 51 in the first embodiment is a square shaped plate having a pair of sides that extend in the left-right direction Y. and a pair of sides that extend in the top-bottom direction Z.

The front side (+X side) of the sensor substrate 51 is attachment surface 51a. The refrigerant sensor 52, the second connector 53, and the IC chip 54 are connected to the attachment surface 51a. The refrigerant sensor 52, the second connector 53, and the IC chip 54 are electrically connected to the sensor substrate 51. The refrigerant sensor 52, the second connector 53, and the IC chip 54 are for example, electrically connected to the sensor substrate 51 by soldering. The sensor substrate 51 is a printed board having a conductor wiring pattern.

The sensor substrate 51 is held by the housing main body 20. The sensor substrate 51 in the first embodiment is held by the substrate holding portion 29. In the first embodiment, the sensor substrate 51 is held using the substrate holding portion 29, by having an outer circumferential edge of the sensor substrate 51 be surrounded and supported by the supports 27a and 27b, and the plurality of ribs 29a, as well as having the elastic claw 25a and the fixed claw 28a hook onto the outer circumferential edge of the sensor substrate 51 from the front side (+X side). The elastic claw 25a hooks onto an edge on the left side of the sensor substrate 51 from the front side. The fixed claw 28a hooks onto an edge on the right side of the sensor substrate 51 from the front side thereof.

The support 27a supports a corner out of the sensor substrate 51 from the left side, the corner being located on the left side as well as the bottom side. The support 27b supports a corner out of the sensor substrate 51 from the left side and the top side, the corner being located on the left side as well as the top side. The plurality of ribs 29a that are formed on a wall portion located on the bottom side out of the inner circumferential wall 22, support an edge on the bottom side of the sensor substrate 51 from the bottom side thereof. The plurality of ribs 29a formed on a wall portion located on the right side out of the inner circumferential wall 22, support the edge on the right side of the sensor substrate 51 from the right side thereof. The plurality of ribs 29a formed on a wall portion on the bottom side of the protruding wall 26a, support an edge on the top side of the sensor substrate 51 from the top side.

The refrigerant sensor 52 is a sensor capable of detecting the refrigerant. The refrigerant sensor 52 in the first embodiment is a semiconductor type refrigerant sensor. It is possible for the refrigerant sensor 52 to be a refrigerant sensor 52 of the refrigerant that is in a gaseous state. As shown in FIG. 2, the refrigerant sensor 52 is a cylindrical shape that extends in the front side (+X side) from the sensor substrate 51. The refrigerant sensor 52 is attached to a bottom side portion on the left side portion of the sensor substrate 51. In the first embodiment, when the refrigerant in a gaseous state that flows to the inside of the housing 10 from an inside of the air intake holes 33 contacts the refrigerant sensor 52, the refrigerant is detected by the refrigerant sensor 52. As such, for example, by disposing the alarm 100 on the bottom in the vertical direction of the indoor unit in the air conditioner, it is possible to detect the refrigerant that has leaked and that flows to the bottom in the vertical direction from the indoor unit, using the refrigerant sensor 52.

As shown in FIG. 6, the second connector 53 is attached to a right side portion of the sensor substrate 51. The cable connector 80b of the cable 80 that extends from the first connector 46 is detachably connected to the second connector 53. By having first connector 46 and the second connector 53 be electrically connected using the cable 80, the sensor substrate 51 is electrically connected to the alarm element substrate 41. The second connector 53 in the first embodiment corresponds to a “first electric part” that is connected to the sensor substrate 51.

The IC chip 54 is attached to the left side on a top side portion of the sensor substrate 51. The IC chip 54 is a rectangular shaped plate having a plate surface that faces the front-rear direction X. The IC chip 54 is located on the top side of the refrigerant sensor 52, as well as the left side of the second connector 53. As shown in FIG. 3, a surface of the front side (+X side) of the IC chip 54 is located more to the rear side (−X side) than an edge on the front side of the refrigerant sensor 52, and an edge on the front side of the second connector 53. In other words, a protrusion height of the IC chip 54 from the attachment surface 51a is smaller than a protrusion height of the refrigerant sensor 52 from the attachment surface 51a, and a protrusion height of the second connector 53 from the attachment surface 51a.

In the first embodiment, the protrusion height of the IC chip 54 from the attachment surface 51a, the protrusion height of the refrigerant sensor 52 from the attachment surface 51a, and the protrusion height of the second connector 53 from the attachment surface 51a are each similar to dimensions of each of the parts in the front-rear direction X.

When the refrigerant sensor 52 detects the refrigerant, the IC chip 54 sends a signal which indicates that the refrigerant is detected by the refrigerant sensor 52 to the alarm element substrate 41, via the cable 80. When a signal is sent from the IC chip 54 to the alarm element substrate 41, the luminous body 45b illuminates, and an alarm which indicates that the refrigerant has leaked is produced from the speaker 42. The IC chip 54 in the first embodiment corresponds to a “second electric part” that is attached to the attachment surface 51a.

As shown in FIG. 3 and in FIG. 4, the alarm 100 includes the covering member 60 that is disposed on the inside of the housing 10. The covering member 60 extends in the top-bottom direction Z. The covering member 60 for example, is made of resin. The covering member 60 is fixed to the housing main body 20 in a state where the covering member 60 covers a portion of the alarm element substrate 41. The covering member 60 in the first embodiment covers said portion of the alarm element substrate 41 from the front side (+X side). More specifically, out of the alarm element substrate 41, the covering member 60 covers a right end on a bottom side portion of the first portion 41a, a left end of the third portion 41c, and the fifth portion 41e from the front side. The covering member 60 sandwiches said portion of the alarm element substrate 41 in between with the housing main body 20, in the front-rear direction X.

FIG. 8 is a perspective view that shows the covering member 60. FIG. 9 is a perspective view that shows the covering member 60, and shows the covering member 60 from a different angle than that of FIG. 8. As shown in FIG. 8 and in FIG. 9, the covering member 60 has an extension 61, a first protrusion 62, a second protrusion 63, an opposite portion 64, and a side wall 65.

The extension 61 extends in the top-bottom direction Z. The extension 61 is a plate shape having a plate surface that faces the front-rear direction X. Bolt holes 61a and 61b that penetrate the extension 61 in the front-rear direction X, are formed on the extension 61. The bolt hole 61a is formed on atop end of the extension 61. The bolt hole 61b is formed on a bottom end of the extension 61. The bolt 70a that fixes the alarm element substrate 41 is inserted to the bolt hole 61a from the front side (+X side). The bolt 70b that fixes the alarm element substrate 41 is inserted to the bolt hole 61b from the front side.

In the first embodiment, by inserting the bolts 70a, 70b through each of the bolt holes 61a, 61b and the bolt holes 48a, 48b formed on the alarm element substrate 41, and fastening each bolt to the thread holes of the substrate fixing portions 24a and 24b, it is possible to fix the covering member 60 and the alarm element substrate 41 to the housing main body 20. In other words, the covering member 60 and the alarm element substrate 41 in the first embodiment are jointly fastened to the housing main body 20 by the bolts 70a and 70b.

As shown in FIG. 9, a circumferential edge of the bolt hole 61a out of a surface on the rear side (−X side) of the extension 61, and a circumferential edge of the bolt hole 61b protrude to the rear side. Said protruding circumferential edges contact the surface on the front side (+X side) of the alarm element substrate 41. Accordingly, the covering member 60 is in contact with the alarm element substrate 41.

The first protrusion 62 is connected to atop side of the extension 61. The first protrusion 62 protrudes to the front side (+X side) from the top end of the extension 61. The first protrusion 62 has a first wall portion 62a that protrudes to the front side from the top end of the extension 61, a second wall portion 62b that extends to the top side from a front end of the first wall portion 62a, and a third wall portion 62c that extends to the rear side (−X side) from a top end of the second wall portion 62b.

As shown in FIG. 3, first wall portion 62a covers the electric parts 47b from the front side (+X side). More specifically, the first wall portion 62a, out of the first protrusion 62, covers the electric parts 47b from the front side. Out of the first protrusion 62, the first wall portion 62a and the third wall portion 62c are disposed so as to sandwich the electric parts 47b in the top-bottom direction Z. By providing the first protrusion 62 so as to protrude to the front side, the covering member 60 is suppressed from interfering with the electric parts 47b. The second wall portion 62b covers the third portion 41c out of the alarm element substrate 41 from the front side. The second wall portion 62b is adjacently disposed to left side of the terminal block 43, as seen from the front side. In the present disclosure, the phrase “an element interfering with another element” means that, said element collides with said other element. In other words, the phrase “an element interfering with another element” in the present disclosure means that said element, which contacts said other element, obstructs a movement and/or correct disposition or the like of said other element.

As shown in FIG. 4, a plurality of displays 66a, 66b, 66c, and 66d are formed on the second wall portion 62b. The display 66a, the display 66b, the display 66c, and the display 66d are disposed in such an order as the bottom side is approached from the top side. In the first embodiment, each of the displays 66a, 66b, 66c, and 66d is an alphanumeric that is formed on a surface of the second wall portion 62b on the front side. In the example of FIG. 4, the display 66a includes alphanumerics “VDD”. The display 66b includes alphanumerics “SIG1”. The display 66c includes alphanumerics “GND”. The display 66d includes alphanumerics “SIG2”.

As seen from the side where the covering member 60 covers the alarm element substrate 41, in other words, the front side (+X side), each of the plurality of displays 66a, 66b, 66c, and 66d that are formed on the second wall portion 62b are disposed so as to be adjacent to the plurality of connectors 43a, 43b, 43c, and 43d in the left-right direction Y. The display 66a is disposed on a left side of the connector 43a. The display 66b is disposed on a left side of the connector 43b. The display 66c is disposed on a left side of the connector 43c. The display 66d is disposed on a left side of the connector 43d.

The plurality of displays 66a, 66b, 66c, and 66d display information pertaining to each of the wires 81a, 81b, 81c, and 81d that are connected to the plurality of connectors 43a, 43b, 43c, and 43d. As information pertaining to each of the wires 81a, 81b, 81c, and 81d, the plurality of displays 66a, 66b, 66c, and 66d in the first embodiment display a type of each of the wires 81a, 81b, 81c, and 81d.

The display 66a shows that the type of the wire 81a connected to the connector 43a is a power line. The display 66b shows that the type of the wire 81b connected to the connector 43b is a signal line. The display 66c shows that the type of the wire 81c connected to the connector 43c is a ground wire. The display 66d shows that the type of the wire 81d connected to the connector 43d is a signal line that differs from the signal line, which is the wire 81b, connected to the connector 43b.

As shown in FIG. 8, the second protrusion 63 is connected to the right side on the top end of the extension 61. The second protrusion 63 protrudes to the front side (+X side) from the extension 61. The second protrusion 63 has a first wall portion 63a that protrudes to the front side from the extension 61, and a second wall portion 63b that protrudes to the top side from a front end of the first wall portion 63a. A connection portion of the first wall portion 63a and the second wall portion 63b are rounded. The second wall portion 63b is a semi-arc shape, as seen from the left-right direction Y. A left end on a top end of the second wall portion 63b is connected to the second wall portion 62b of the first protrusion 62. As shown in FIG. 3, the second protrusion 63 covers the electric parts 47c from the front side. By providing the second protrusion 63 so as to protrude to the front side, the covering member 60 is suppressed from interfering with, in other words colliding with the electric parts 47c.

A side wall 65 protrudes to the front side (+X side) from a left end of the extension 61, and from a left end of the first protrusion 62. The side wall 65 extends in the top-bottom direction Z. The side wall 65 is disposed so as to face the speaker 42 from a right side thereof.

As shown in FIG. 8, the opposite portion 64 is connected to a bottom end of the second protrusion 63. The opposite portion 64 protrudes to the bottom side from and end on the rear side (−X side) of the first wall portion 63a. The opposite portion 64 is a plate shape having a plate surface that faces the front-rear direction X. The opposite portion 64 is a semi-rectangular plate. The opposite portion 64 has a base 64a that is connected to the first wall portion 63a, an opposite portion main body 64b that is connected to a bottom side of the base 64a, and a rib 64e that is formed on a center part in the left-right direction Y on a front side (+X side) surface of the base 64a.

A step 64c that protrudes to the front side (+X side) as the opposite portion main body 64b is approached from the base 64a along the opposite portion 64, is provided between the base 64a and the opposite portion main body 64b. The opposite portion main body 64b is located more to the front side than the base 64a. The rib 64e extends in the top-bottom direction Z, and is connected to the opposite portion main body 64b, and the to the first wall portion 63a.

A notch 64e is formed on an end on the bottom side and the left side, out of the opposite portion main body 64b. As seen from the front-rear direction X, the notch 64d extends in a direction located on the top side, as the left side is approached. As shown in FIG. 4, by forming the notch 64d, the elastic claw 25a is suppressed from interfering, in other words, colliding with the opposite portion 64.

As shown in FIG. 3 and in FIG. 4, the opposite portion 64 is disposed so as to face the sensor substrate 51. The opposite portion 64 in the first embodiment is disposed so as to face the front side (+X side) of the sensor substrate 51 with an interval therebetween. In other words, the opposite portion 64 is disposed so as to face the attachment surface 51a with an interval therebetween. The opposite portion 64 in the first embodiment covers an end of the top side on an end of the left side out of the sensor substrate 51, from the front side.

A dimension of an interval between the opposite portion 64 and the attachment surface 51a is smaller than a dimension in the front-rear direction X of the refrigerant sensor 52, and a dimension in the front-rear direction X of the second connector 53. In other words, the protrusion height of the refrigerant sensor 52 from the attachment surface 51a and a protrusion height of the second connector 53 from the attachment surface 51a, are larger than said dimension of the interval between the opposite portion 64 and the attachment surface 51a. Said interval between the opposite portion 64 and the attachment surface 51a is larger than a dimension of the IC chip 54 in the front-rear direction X.

The opposite portion 64 covers at least a portion of the IC chip 54 from the front side (+X side). Accordingly, at least a portion of the IC chip 54 is disposed between the opposite portion 64 and the sensor substrate 51 in the front-rear direction X. In the first embodiment, the opposite portion main body 64b out of the opposite portion 64 covers a left side portion of the IC chip 54 from the front side. In other words, in the first embodiment, the left side portion of the IC chip 54 is located between the opposite portion 64 and the sensor substrate 51 in the front-rear direction X.

When the sensor substrate 51 is attached to the housing main body 20 in a different orientation, the opposite portion 64 interferes with at least one of the refrigerant sensor 52 or the second connector 53. In other words, in a case where the sensor substrate 51 is attached to the housing main body 20 in a different orientation, the opposite portion 64 collides with at least one of the refrigerant sensor 52 or the second connector 53. Details are explained below.

In the first embodiment, other than the orientation shown in FIG. 3 to FIG. 6, it is possible to attach the sensor substrate 51 to the substrate holding portion 29 as in three orientations, shown as the orientation of FIG. 10A, the orientation of FIG. 10B, and the orientation of FIG. 10C. FIG. 10A is a view that shows the sensor substrate 51 in a state of being attached to the housing main body 20 in a different orientation. FIG. 10B is a view that shows the sensor substrate 51 in a state of being attached to the housing main body 20 in another different orientation. FIG. 10C is a view that shows the sensor substrate 51 in a state of being attached to the housing main body 20 in yet another different orientation.

The orientation of the sensor substrate 51 shown in FIG. 10A is the orientation of the sensor substrate 51 shown in FIG. 3 and in FIG. 6, rotated 90 degrees clockwise, as seen from the front side (+X side). The orientation of the sensor substrate 51 as shown in FIG. 10B is the orientation of the sensor substrate 51 shown in FIG. 3 and in FIG. 6, rotated 180 degrees clockwise, as seen from the front side. The orientation of the sensor substrate 51 as shown in FIG. 10C is the orientation of the sensor substrate 51 shown in FIG. 3 and in FIG. 6, rotated 270 degrees clockwise, as seen from the front side. In the first embodiment, the orientation of the sensor substrate 51 shown in FIG. 3 and in FIG. 6 is the correct orientation, and each of the orientations of the sensor substrate 51 shown in FIG. 10A to FIG. 10C are incorrect orientations.

As shown in FIG. 10A, in the orientation of the sensor substrate 51 shown in FIG. 10A, a portion of the refrigerant sensor 52 is disposed in a location that overlaps with a portion of the opposite portion 64, as seen from the front-rear direction X. Since the refrigerant sensor 52 protrudes to the front side (+X side) more than the opposite portion 64, when the refrigerant sensor 52 is disposed in a location that overlaps with the opposite portion 64 in the front-rear direction X, the opposite portion 64 interferes with the refrigerant sensor 52, and it is not possible to dispose the opposite portion 64. In other words, when the refrigerant sensor 52 is disposed in a location that overlaps with the opposite portion 64 in the front-rear direction X, the opposite portion 64 collides with the refrigerant sensor 52 from the front direction when trying to attach the covering member 60 to the housing main body 20, and it is not possible to dispose the opposite portion 64 in the correct location. Therefore, when the sensor substrate 51 is attached to the housing main body 20 in the orientation shown in FIG. 10A, it is not possible to attach the covering member 60 to the housing main body 20.

As shown in each of FIG. 10B and in FIG. 10(C, a portion of the second connector 53 is disposed in a location that overlaps with the opposite portion 64 as seen from the front-rear direction X, in the orientation of the sensor substrate 51 shown in FIG. 10B, and the orientation of the sensor substrate 51 shown in FIG. 10C. Since the second connector 53 protrudes to the front (+X side) more than the opposite portion 64, by disposing the second connector 53 in a location that overlaps with the opposite portion 64 in the front-rear direction X, the opposite portion 64 interferes with the second connector 53, and it is not possible to dispose the opposite portion 64. In other words, when the second connector 53 is disposed in a location that overlaps with the opposite portion 64 in the front-rear direction X, the opposite portion 64 collides with the second connector 53 from the front side when trying to attach the covering member 60 to the housing main body 20, and it is not possible to dispose the opposite portion 64 in the correct location. Therefore, when attaching the sensor substrate 51 to the housing main body 20 in the orientation shown in FIG. 10B, or in the orientation shown in FIG. 10C, it is not possible to attach the covering member 60 to the housing main body 20.

From the above, when the sensor substrate 51 is attached to the housing main body 20 in the incorrect orientations shown in FIG. 10A and FIG. 10C, at least a portion of the opposite portion 64 collides with the refrigerant sensor 52 and/or with the second connector 53, and it is not possible to attach the covering member 60 to the housing 20. On the other hand, when the sensor substrate 51 is attached to the housing main body 20 in the correct orientation shown in FIG. 3 and in FIG. 6, since the opposite portion 64 does not collide with either of the refrigerant sensor 52 or the second connector 53, it is possible to attach the covering member 60 to the housing main body 20.

In the first embodiment, an operator conducting exchange work of the refrigerant sensor 52 first removes the lid 30 from the housing main body 20, then removes the bolts 70a and 70b in order to detach the covering member 60. The operator then removes the cable connector 80b of the cable 80 from the second connector 53, and elastically deforms the elastic claw 25a to the left side so as to remove the elastic claw 25a from the sensor substrate 51, therefore removing the second substrate unit 50 from the substrate holding portion 29. Next, after attaching a new second substrate unit 50 having a new refrigerant sensor 52 to the substrate holding portion 29, the operator is able to once more fix the covering member 60 to the housing main body 20 using the bolts 70a and 70b. The operator then once again fixes the lid 30 to the housing main body 20. With the above, the operator is able to replace the refrigerant sensor 52.

According to the first embodiment, the alarm 100 includes the refrigerant sensor 52 capable of detecting the refrigerant, the speaker 42 and the luminous body 45b as alarm elements that are capable of notifying whether the refrigerant is detected by the refrigerant sensor 52, the alarm element substrate 41 to which the speaker 42 and the luminous body 45b are attached to, the sensor substrate 51 to which the refrigerant sensor 52 is attached to, and the housing 10 which houses the alarm element substrate 41 and the sensor substrate 51. The sensor substrate 51 is a separate body from the alarm element substrate 41, and is electrically connected to the alarm element substrate 41. The housing 10 has the housing main body 20 to which the alarm element substrate 41 and the sensor substrate 51 are held, and the lid 30 which is detachably fixed to the housing main body 20, and covers the alarm element substrate 41 and the sensor substrate 51. The sensor substrate 51 is detachably fixed to the housing main body 20.

As such, as previously explained, it is possible to remove the sensor substrate 51 having the refrigerant sensor 52 attached thereto from the housing main body 20, without the need to remove the alarm element substrate 41 from the housing main body 20. Accordingly, it is possible to exchange the refrigerant in a case where the refrigerant that is detected by the semiconductor type refrigerant sensor 52 is already used, and/or it is possible to exchange the refrigerant sensor 52 in a case where a malfunction occurs in the refrigerant sensor 52 or the like, without the need to exchange the speaker 42 and the luminous body 45b as alarm elements. Therefore, it is possible to reduce time and cost required to exchange the refrigerant sensor 52. From the above, in the alarm 100 according to the first embodiment, it is possible to easily exchange the refrigerant sensor 52.

In the first embodiment, by removing the lid 30 and the covering member 60, it is possible to also remove the first substrate unit 40. As such, it is possible for an operator to easily exchange the speaker 42 and the luminous body 45b that are attached to the alarm element substrate 41 as alarm elements.

According to the first embodiment, the alarm 100 includes the covering member 60 disposed on the inside of the housing 10. The covering member 60 is fixed to the housing main body 20 in a state where the covering member 60 covers a portion of the alarm element substrate 41. As such, it is possible to have a portion of the alarm element substrate 41 be protected by the covering member 60. Accordingly, it is possible to suppress the alarm element substrate 41 and/or the parts that are attached to the alarm element substrate 41 from being damaged. It is also possible to suppress the operator from unintentionally contacting the alarm element substrate 41 and/or the parts that are attached to the alarm element substrate 41. Also, since it is possible to hold down the alarm element substrate 41 using the covering member 60, stably holding the alarm element substrate 41 on the inside of the housing 10 is easier.

According to the first embodiment, the covering member 60 sandwiches a portion of the alarm element substrate 41 in between with the housing main body 20, and is connected to the alarm element substrate 41. As such, it is possible to further stably fix the alarm element substrate 41 to the housing main body 20 using the covering member 60.

According to the first embodiment, the covering member 60 and the alarm element substrate 41 are jointly attached to the housing main body 20 by the bolts 70a and 70b. As such, it is possible to firmly fix the covering member 60 and the alarm element substrate 41 to the housing main body 20. By being able to firmly fix the alarm element substrate 41, it is possible to suppress vibration of the alarm element substrate 41, when the speaker 42 vibrates as sound is being produced from the speaker 42. Accordingly, it is possible to suppress noise and sounds other than the alarm from being produced by the speaker 42.

According to the first embodiment, the alarm 100 includes the second connector 53, which is attached to the sensor substrate 51 as the first electric part. The covering member 60 has the opposite portion 64 disposed so as to face the sensor substrate 51. The opposite portion 64 collides with at least one of the refrigerant sensor 52 or the second connector 53, when the sensor substrate 51 is attached to the housing main body 20 in a different orientation. Therefore, as previously mentioned, when the sensor substrate 51 is attached to the housing main body 20 in an incorrect orientation, the opposite portion 64 collides with at least one of the refrigerant sensor 52 or the second connector 53, and it is not possible to attach the covering member 60. As such, by having the operator realize that the sensor substrate 51 is attached in an incorrect orientation, it is possible to suppress the sensor substrate 51 from being attached to the housing main body 20 in an incorrect orientation. Therefore, for example, it is possible to suppress having the location of the refrigerant sensor 52 attached to the sensor substrate 51 be far from the air intake holes 33, and it is possible to suppress having the refrigerant be harder to detect by the refrigerant sensor 52. It is also possible, for example, to suppress having the location of the second connector 53, be far from the first connector 46 attached to the alarm element substrate 41, and it is possible to suppress having the alarm element substrate 41 and the sensor substrate 51 be harder to connect due to the presence of the cable 80.

According to the first embodiment, the housing main body 20 has the elastic claw 25a and the fixed claw 28a, which detachably fix the sensor substrate 51 thereto. The elastic claw 25a and the fixed claw 28a are hooked onto an edge of the sensor substrate 51 from the front side, in the front-rear direction X. The elastic claw 25a and the fixed claw 28a are disposed so as to sandwich the sensor substrate 51 in the left-right direction Y which is orthogonal to the front-rear direction X. The elastic claw 25a is elastically deformable in the left-right direction Y. As such, along with being able to hold down and fix the sensor substrate 51 to the housing main body 20 from the front side using the elastic claw 25a and the fixed claw 28a, it is possible to remove the elastic claw 25a from the edge of the sensor substrate 51 by elastically deforming the elastic claw 25a in the left-right direction Y. Accordingly, it is possible to remove the sensor substrate 51 from the housing main body 20. Therefore, it is possible to suitably attach and detach the sensor substrate 51 with respect to the housing main body 20. Since it is possible to attach and detach the sensor substrate 51 by elastically deforming the elastic claw 25a, there is no need to use thread members such as bolts or the like, and it is possible to easily conduct attachment and detachment work of the sensor substrate 51 from the housing main body 20. There is also no need to separately provide a thread member, which makes it possible to suppress the number of parts of the alarm 100 from increasing.

According to the first embodiment, the sensor substrate 51 has the attachment surface 51a, which has the refrigerant sensor 52, and the second connector 53 as the first electric part, attached thereto. The opposite portion 64 is disposed so as to face the attachment surface 51a at an interval. The protrusion height of the refrigerant sensor 52 from the attachment surface 51a and the protrusion height of the second connector 53 from the attachment surface 51a, are larger than the interval between the opposite portion 64 and the attachment surface 51a. As such, it is not possible to dispose the opposite portion 64 so as to overlap with the refrigerant sensor 52 and with the second connector 53, as seen from the front-rear direction X which is orthogonal to the attachment surface 51a. Accordingly when the sensor substrate 51 is disposed in an incorrect orientation, it is possible to have either of the refrigerant sensor 52 or the second connector 53 be disposed so as to suitably interfere with, or in other words, collide with the opposite portion 64. Therefore, it is possible to further suitably suppress the sensor substrate 51 from being attached to the housing main body 20 in an incorrect orientation.

According to the first embodiment, the alarm 100 includes the IC chip 54 attached to the attachment surface 51a as the second electric part. At least a portion of the IC chip 54 is disposed between the opposite portion 64 and the sensor substrate 51. As such, when the sensor substrate 51 is attached in the correct orientation, it is possible to use a region where at least a portion that faces the opposite portion 64 that does not interfere, in other words, collide with the opposite portion 64 out of the sensor substrate 51, as the region to dispose the IC chip 54. Accordingly, it is possible to suppress a decrease in mounting space of the attachment surface 51a, even when the opposite portion 64 is made to face the attachment surface 51a. In the first embodiment, by providing the step 64c in the opposite portion 64 so as to separate the opposite portion main body 64b more to the front side (+X side) from the attachment surface 51a, it is possible to suppress the opposite portion 64 from interfering with, in other words, colliding with the IC chip 54.

According to the first embodiment, the alarm 100 includes the terminal block 43, which has the alarm element substrate 41 having a plurality of the connectors 43a, 43b, 43c, and 43d connected thereto. The covering member 60 has the plurality of displays 66a, 66b, 66c, and 66d that display information pertaining to each of the wires 81a, 81b, 81c, and 81d that are connected to each of the plurality of connectors 43a, 43b, 43c, and 43d. As such, it is easy for the operator to grasp which wire out of a plurality of wires 81a, 81b, 81c, and 81d is connected to which connector out of the plurality of connectors 43a, 43b. 43c, and 43d, when conducting connection work of the wires 81a, 81b, 81c, and 81d to the connectors 43a, 43b, 43c, and 43d, by referring to each of the displays 66a, 66b, 66c, and 66d. Accordingly, it is possible to suppress having the wrong wire out of the wires 81a, 81b. 81c, and 81d from being connected to the wrong connector out of each of the connectors 43a, 43b, 43c, and 43d.

According to the first embodiment, each of the plurality of displays 66a, 66b. 66c, and 66d is adjacently disposed to each of the plurality of connectors 43a, 43b, 43c, and 43d, as seen from a side (+X side) where the covering member 60 covers the alarm element substrate 41. As such, by referring to each of the displays 66a, 66b, 66c, and 66d, it is possible for the operator to suitably grasp which wire out of each of the wires 81aa, 81b, 81c, and 81d needs to be connected to which connector out of each of the connectors 43a, 43b, 43c, and 43d. Accordingly, it is possible to suitably suppress having each of the connectors 43a, 43b, 43c, and 43d from being connected each of the incorrect wires 81a, 81b, 81c, and 81d.

According to the first embodiment, the alarm elements that are attached to the alarm element substrate 41 include at least one of the speaker 42, or the luminous body 45b. As such, it is possible for the alarm 100 to notify the user or the like that the refrigerant has leaked by at least producing a sound or alight. Accordingly, it is possible to suitably notify the user or the like that the refrigerant has leaked. In the first embodiment, since the speaker 42 and the luminous body 45b are provided as alarm elements, it is possible to further suitably notify the user or the like that the refrigerant has leaked.

### Second Embodiment

FIG. 11 is a view that shows a part of an alarm 200 from the front side (+X side) in a second embodiment. FIG. 12 is a view that shows a sensor substrate 251 in a state of being attached to the housing main body 20 in a different orientation, in the second embodiment. An orientation of the sensor substrate 251 in FIG. 12 is the orientation of the sensor substrate 251 shown in FIG. 11, rotated 180 degrees clockwise, as seen from the front side (+X side). In the second embodiment, the orientation of the sensor substrate 251 shown in FIG. 11 is the correct orientation, and the orientation of each of component of the sensor substrate 251 shown in FIG. 12 is the incorrect orientation. In the explanations below, configurations similar to the configurations previously mentioned have the same reference signs and the like affixed thereto, with explanations thereof being omitted.

As shown in FIG. 11, the alarm 200 in the second embodiment has a second substrate unit 250, a sensor substrate 251, the refrigerant sensor 52, the second connector 53, and an IC chip 254. The refrigerant sensor 52, the second connector 53, and the IC chip 254 are attached to an attachment surface 251a, which is a front side (+X side) surface of the sensor substrate 251.

The sensor substrate 251 is a long semi-rectangular shaped plate in the left-right direction Y. Out of four corners of the sensor substrate 251, a chamfer 251c is formed on a chamfered surface that is formed on a bottom left side. Out of the four corners of the sensor substrate 251, a chamfer 251d is formed on a chamfered surface that is formed on a top left side.

Similar to the first embodiment, the sensor substrate 251 is held to the substrate holding portion 29. In the second embodiment, the sensor substrate 251 is held to the substrate holding portion 29 by having an outer circumferential edge of the sensor substrate 251 be supported by the supports 27c and 27d, and the ribs 29a, and by having the elastic claw 25b and the fixed claw 28b hook onto the outer circumferential edge of the sensor substrate 251 from the front side (+X side). The elastic claw 25b is hooked onto an edge on the left side of the sensor substrate 251 from the front side. The fixed claw 28b is hooked onto an edge on the right side of the sensor substrate 251 from the front side.

As such, it is possible to attach the semi-rectangular plate sensor substrate 51 as in the first embodiment, and the long semi-rectangular shaped plate sensor substrate 251 as in the second embodiment, to the substrate holding portion 29 in the housing main body 20. In the second embodiment, the elastic claw 25b and the fixed claw 28b are claw portions that detachably fix the sensor substrate 251. In the second embodiment, the elastic claw 25b corresponds to the “first claw”, and the fixed claw 28b corresponds to the “second claw”.

The chamfer 251c is disposed so as to face the support 27c. A surface that faces the chamfer 251c out of the support 27c extends along the chamfer 251c, as seen from the front-rear direction X. The chamfer 251d is disposed so as to face the support 27d. A surface that faces the chamfer 251d out of the support 27d extends along the chamfer 251d, as seen from the front-rear direction X. Other configurations of the sensor substrate 251 are the same as the other configurations of the sensor substrate 51 in the first embodiment.

The IC chip 254 is attached to a center part in the left-right direction Y on a bottom side portion out of the sensor substrate 251. The IC chip 254 is located to the right side more than the refrigerant sensor 52, and is located more to the left side more than the second connector 53. The IC chip 254 is not disposed between the opposite portion 64 and the sensor substrate 251. Other configurations of the IC chip 254 are the same as the other configurations of the IC chip 54 in the first embodiment. Other configurations of the alarm 200 are the same as the other configurations of the alarm 100 in the first embodiment.

In the second embodiment, for example, when the sensor substrate 251 shown in FIG. 12 is held by the substrate holding portion 29 in the incorrect orientation, the second connector 53 and the opposite portion 64 collide with one another, as in the first embodiment. As such, even in the second embodiment, it is possible to suppress the sensor substrate 251 from being attached to the housing main body 20 in the incorrect orientation.

In the second embodiment, since only two corners out of the four corners of the long semi-rectangular shaped plate sensor substrate 251 have chamfers 251c and 251d provided, and the supports 27c and 27d are each disposed so as to face each of the chamfers 251c and 251d on the substrate holding portion 29, it is possible to suppress the sensor substrate 251 from being attached to the housing main body 20 in the incorrect orientation. In other words, by not chamfering the corner on the bottom right side and the corner on the top right side out of the four corners of the sensor substrate 251 as shown in FIG. 11, when trying to attach the sensor substrate 251 in an inverted manner in the left-right direction Y, it is possible for the corners that are not chamfered to interfere with the supports 27c and 27d. In other words, when trying to attach the sensor substrate 251 in an inverted manner in the left-right direction Y, the corners that are not chamfered collide with the supports 27c and 27d from the front side, and it is not possible to dispose the corners that are not chamfered in the correct location. Accordingly, it is possible to suppress having the sensor substrate 251 from being attached to the substrate holding portion 29 in an incorrect orientation.

Since the sensor substrate 251 shown in FIG. 12 has all four corners thereof chamfered, it is possible to attach the sensor substrate 251 to the substrate holding portion 29 in an inverted orientation, with respect to the orientation thereof in the left-right direction Y shown in FIG. 11. However, as previously mentioned, when disposing the sensor substrate 251 in said orientation, since the opposite portion 64 interferes with, in other words, collides with the second connector 53, it is not possible to attach the covering member 60. As such, as shown in FIG. 12, even when all four corners of the sensor substrate 251 are chamfered, it is still possible to suppress having the sensor substrate 251 from being attached to the housing main body 20 in the incorrect orientation.

### Third Embodiment

FIG. 13 is a view that shows a part of an alarm 300 from the front side (+X side), in a third embodiment. In the explanations below, configurations similar to the configurations previously mentioned have the same reference signs and the like affixed thereto, with explanations thereof being omitted.

As shown in FIG. 13, a substrate holding portion 329 in a housing main body 320 of the third embodiment differs from the substrate holding portion 29 of the first embodiment, in that the substrate holding portion 329 does not have the fixed claws 28a and 28b. The substrate holding portion 329 has a thread hole 329b. The thread hole 329b is formed in a location that overlaps with a sensor substrate 351 out of a rear wall 321, as seen from the front-rear direction X. The thread hole 329b in the third embodiment is located to the bottom side more than the second connector 53, and more to the right side than the refrigerant sensor 52. Although not shown on the drawings, a portion out of out of the rear wall 321 onto which the thread hole 329b is formed, protrudes to the front side (+X side), and contacts a surface on the rear side (−X side) of the sensor substrate 351. Other configurations of the rear wall 321 are the same as the other configurations of the rear wall 21 of the first embodiment. Other configurations of the substrate holding portion 329 are the same as the other configurations of the substrate holding portion 29 of the first embodiment.

A fixing hole 351b that penetrates the sensor substrate 351 in the front-rear direction X is formed on the sensor substrate 351 of a second substrate unit 350. The fixing hole 351b is formed in a location that overlaps with the thread hole 329b, as seen from the front-rear direction X. The fixing hole 351b is located on the front side (+X side) of the thread hole 329b.

The sensor substrate 351 in the third embodiment is detachably fixed to the housing main body 320 by a thread member 390 and the elastic claw 25a. In other words, the sensor substrate 351 is fixed to the housing main body 320 using the thread member 390, instead of the fixed claw 28a as in the first embodiment. The thread member 390 is a bolt that is inserted through an inside of the fixing hole 351b from the front side (+X side) of the sensor substrate 351, and is a bolt that is fastened to the thread hole 329b. The thread member 390 in the third embodiment fixes a bottom side portion out of a right side portion of the sensor substrate 351 to the housing main body 320.

Other configurations of the sensor substrate 351 are the same as the other configurations of the sensor substrate 51 of the first embodiment. Other configurations of the second substrate unit 350 are the same as the other configurations of the second substrate unit 50 of the first embodiment. Other configurations of the alarm 300 are the same as the other configurations of the alarm 100 of the first embodiment.

According to the third embodiment, the alarm 300 includes the thread member 390 that detachably fixes the sensor substrate 351 to the housing main body 320. As such, the sensor substrate 351 is firmly and securely fixed to the housing main body 320 using the thread member 390. Since it is possible to fix the sensor substrate 351 using the thread member 390, it is possible to reduce a number of claws required to fix the sensor substrate 351. Accordingly, simplifying the construction of the housing main body 320 becomes easier. Specifically, in the third embodiment, since the fixed claws 28a and 28b are not required, simplifying the construction of the housing main body 320 is easier.

### Fourth Embodiment

FIG. 14 is a view that shows a part of an alarm 400 from the front side (+X side), in a fourth embodiment. In the explanations below, configurations similar to the configurations previously mentioned have the same reference signs and the like affixed thereto, with explanations thereof being omitted.

As shown in FIG. 14, a substrate holding portion 429 in a housing main body 420 of the fourth embodiment differs from the substrate holding portion 29 of the first embodiment, in that the substrate holding portion 429 has no elastic claws 25a and 25b, and no fixed claws 28a and 28b. The substrate holding portion 429 has thread holes 429b and 429c. The thread holes 429b and 429c are formed on locations that overlap with the sensor substrate 451 out of a rear wall 421, as seen from the front-rear direction X. The thread hole 429b is the same configuration as the thread hole 329b of the third embodiment. The thread hole 429c is located to the top side more than the refrigerant sensor 52, and to the left side more than the second connector 53. Although omitted from the drawings, portions out of the rear wall 421 onto which the thread holes 429b and 429c are formed, protrude to the front side (+X side), having front ends thereof contact a surface on the rear side (−X side) of the sensor substrate 451. Other configurations of the rear wall 421 are the same as the other configurations of the rear wall 21 of the first embodiment. Other configurations of the substrate holding portion 429 are the same as the other configurations of the substrate holding portion 29 of the first embodiment.

Fixing holes 451b and 451c that penetrate the sensor substrate 451 in the front-rear direction X, are formed on the sensor substrate 451 of a second substrate unit 450. The fixing hole 451b is the same configuration as the fixing hole 351 of the third embodiment. The fixing hole 451c is formed in a location that overlaps with the thread hole 429c, as seen from the front-rear direction X. The fixing hole 451c is located on the front side (+X side) of the thread hole 429c.

The sensor substrate 451 in the fourth embodiment is detachably fixed to the housing main body 420, only by a first thread member 491 and a second thread member 492. In other words, the sensor substrate 451 is fixed to the housing main body 420 using the first thread member 491 and the second thread member 492 which are two thread members, instead of the elastic claw 25a and the fixed claw 28a as in the first embodiment. The first thread member 491 is a bolt that is inserted through an inside of the fixing hole 451b from the front side (+X side) of the sensor substrate 451, and is fastened to the thread hole 429b. The first thread member 491 has the same configuration as the thread member 390 of the third embodiment. The second thread member 492 is a bolt that is inserted through an inside of the fixing hole 451c from the front side of the sensor substrate 451, and is fastened to the thread hole 429c. The second thread member 492 in the fourth embodiment fixes a top side portion out of a left side portion of the sensor substrate 451 to the housing main body 420. At least a portion of the second thread member 492 is located between the IC chip 54 and the refrigerant sensor 52 in the top-bottom direction Z.

Other configurations of the sensor substrate 451 are the same as the other configurations of the sensor substrate 51 of claim 1. Other configurations of the second substrate unit 450 are the same as the other configurations of the second substrate unit 50 of the first embodiment. Other configurations of the alarm 400 are the same as the other configurations of alarm 100 of the first embodiment.

According to the fourth embodiment, the alarm 400 includes the first thread member 491 and the second thread member 492 as two thread members that detachably fix the sensor substrate 451 to the housing main body 420. The sensor substrate 451 is detachably fixed to the to the housing main body 420 using the two thread members, the first thread member 491 and the second thread member 492. As such, the sensor substrate 451 is firmly and securely attached to the housing main body 420 using the first thread member 491 and the second thread member 492. As such, by fixing the sensor substrate 451 using the two thread members, there is no need to provide claws to fix the sensor substrate 451 to the housing main body 420, and it is possible to securely fix the sensor substrate 451. Accordingly, it is possible to further suitably simplify a construction of the housing main body 420. Specifically in the fourth embodiment, since there is no need to provide the elastic claws 25a and 25b, and the fixed claws 28a and 28b, further suitably simplifying the construction of the housing main body 420 is easier.

Although embodiments of the present disclosure have been described above, the present disclosure is not limited to the configurations of the aforementioned various embodiments, and it is possible to adopt the configurations and the methods described below.

So long as a refrigerant sensor is an element capable of detecting a refrigerant, the refrigerant sensor may be any element. The refrigerant sensor may be a refrigerant sensor other than a semiconductor type. So long as an alarm element is capable of notifying that the refrigerant is detected by the refrigerant sensor, the alarm element may be any element. The alarm element for example, may be a display device such as a display or the like which shows alphanumerics when the refrigerant is detected. A number of the alarm elements is not limited, so long as the number is greater than or equal to one. A first electric part and a second electric part that are attached to a sensor substrate may be any electric part. The first electric part for example, may be a capacitor or the like. The second electric part for example, may be a transistor or the like.

So long as the sensor substrate is fixed so as to be detachable from a housing main body, there is not limitation as to how the sensor substrate is fixed. For example, by having the sensor substrate be a sliding type where the slide sensor is moved by sliding, the sensor substrate may be detachably fixed to the housing main body by having a portion thereof be a slide fixing portion that is disposed in a state such as to face a side (front side) of a first direction of the sensor substrate. It is possible to switch between a location where a part of the slide fixing portion overlaps with the sensor substrate in the first direction (front-rear direction X), and a location where an entirety thereof does not overlap with the sensor substrate in the first direction, by having the slide fixing portion move to a second direction (left-right direction Y) which is orthogonal to the first direction. The slide fixing portion has an engagement portion that hooks to the sensor substrate, when said part of the slide fixing portion overlaps with the sensor substrate in the first direction. By having the engagement part hook onto the sensor substrate, it is possible to detachably fix the sensor substrate to the housing main body using the slide fixing portion. By applying a force to the slide fixing portion in a sliding direction, towards a location where the entirety of the slide fixing portion does not overlap with the sensor substrate in the first direction, it is possible for an operator to release an engagement of the hook of the engagement part from the sensor substrate. Accordingly, it is possible to remove sensor substrate from the housing main body.

The sensor substrate may also be rotatably and detachably fixed to the housing main body, when the sensor substrate, which is rotatable, has a portion thereof be a rotation fixing portion that is disposed in a state such as to face a side of a first direction of the sensor substrate. In such case, besides an aspect of rotation as opposed to sliding, a configuration of the rotation fixing portion is the same as the configuration of the slide fixing portion mentioned above.

For example, the sensor substrate may be detachably fixed to the housing main body using three or more thread members. The sensor substrate may be detachably fixed to the housing main body using two or more of the thread members, and one or more claw portion. The sensor substrate may be fixed to the housing main body using a combination out of the claw portion, the thread member, the previously mentioned slide fixing portion, or the previously mentioned rotation fixing portion. The sensor substrate may be fixed to the housing main body using a combination of two or more out of the claw portion, the thread member, the previously mentioned slide fixing portion, or the previously mentioned rotation fixing portion. In the third and fourth embodiments, examples where the sensor substrate having the same shape as the sensor substrate in the first embodiment is fixed to the housing main body using the thread member is shown, and the sensor substrate having the same shape as the sensor substrate in the second embodiment may be fixed to the housing main body using the thread members, as in the third and fourth embodiments.

So long as a covering member is fixed to the housing main body, in a state where the covering member covers a portion of the alarm element, a configuration thereof is not limited. The covering member need not contact the alarm element. The covering member may be fixed to the housing main body separately from the alarm element. When the sensor substrate is attached in a different orientation with respect to the housing main body, an opposite portion that is disposed so as to face the sensor substrate, may collide with both the refrigerant sensor and the first electric part. A shape of the opposite portion is not particularly limited. The covering member need not have an opposite portion.

So long as each of a plurality of displays that are formed on the covering member displays information pertaining to wires connected to a plurality of connection portions of a terminal block, the plurality of displays may have any configuration. The plurality of displays need not display alphanumerics, and may display symbols. The information pertaining to the wires that the plurality of displays display may be information that pertains to colors of the wires, or information that pertains to sizes of the wires. The plurality of displays need not be provided.

The alarm of the present disclosure may be used for any application. The alarm may be used to detect a refrigerant leak for a refrigerant other than a refrigerant of a refrigeration cycle device of an air conditioner, and may be used for a refrigerant leak of a device other than a refrigeration cycle device. A setup location of the alarm is not particularly limited. The various configurations and methods of the present disclosure mentioned above may be combined, so long as no conflicts regarding the technical scope thereof occur.

1. An alarm comprising:
a refrigerant sensor capable of detecting a refrigerant;
an alarm element that is capable of notifying whether the refrigerant is detected by the refrigerant sensor;
an alarm element substrate to which the alarm element is attached to;
a sensor substrate to which the refrigerant sensor is attached to, and
a housing that houses the alarm element and the sensor substrate on an inside thereof, wherein
the sensor substrate is a separate body from the alarm element substrate, and is electrically connected to the alarm element substrate,
the housing has
a housing main body that holds the alarm element substrate and the sensor substrate, and
a lid that is detachably fixed to the housing main body, and that covers the alarm element substrate and the sensor substrate, and
the sensor substrate is detachably fixed to the housing main body.

2. The alarm according to claim 1 further comprising:
a covering member that is fixed to the housing main body, in a state where the covering member covers a portion of the alarm element substrate.

3. The alarm according to claim 2, wherein
the covering member sandwiches a portion of the alarm element substrate in between with the housing main body, and is in contact with the alarm element substrate.

4. The alarm according to claim 3, wherein
the covering member and the alarm element substrate are jointly fastened to the housing main body by a bolt.

5. The alarm according to claim 2 further comprising:
a first electric part that is connected to the sensor substrate, wherein
the covering member has an opposite portion that is disposed so as to face the sensor substrate, and
when the sensor substrate is attached to the housing main body in a different orientation, the opposite portion collides with at least one of the refrigerant sensor or the first electric part.

6. The alarm according to claim 1, wherein
the housing main body has a first claw and a second claw that detachably fix the sensor substrate,
the first claw and the second claw hook onto an edge of the sensor substrate from one side,
the first claw and the second claw are disposed so as to sandwich the sensor substrate in a second direction, which is orthogonal to a first direction, and
the first claw is elastically deformable in the second direction.

7. The alarm according to claim 1, wherein
the alarm element includes one of a speaker, or a luminous body.
